(19) United States
(12) Patent Application Publication
(10) Pub. No.: US 2011/0170215 A1
(43) Pub. Date: Jul. 14, 2011

(54) ASYMMETRIC DISK CLAMP AND SPINDLE MOTOR ASSEMBLY INCLUDING ASYMMETRIC DISK CLAMP

(75) Inventors: Jae-hyuk HAN, Seoul (KR); Sung-wook Kim, Suwon-si (KR); Yu-sung Kim, Seoul (KR); Hong-taek Lim, Suwon-si (KR)

(73) Assignee: Samsung Electronics Co., Ltd., Suwon-si (KR)

(21) Appl. No.: 12/987,295

(22) Filed: Jan. 10, 2011

(30) Foreign Application Priority Data
Jan. 14, 2010 (KR) 2010-3566

(51) Int. Cl. G11B 17/028

(52) U.S. Cl. 360/99.12; G9B/17.006

(57) ABSTRACT

A spindle motor assembly includes a spindle motor, a disk for storing data, the disk being installed on the spindle motor, and a disk clamp for fixing the disk to the spindle motor. The disk clamp includes a hollow formed in a central portion thereof, a coupling portion formed around an external circumference of the hollow and including a plurality of screw insertion holes into which clamp fastening screws to be coupled to the spindle motor are inserted, and a pressing portion formed around an external circumference of the coupling portion to press the disk. The coupling portion includes a first region and a second region that are asymmetrical with respect to each other, the plurality of screw insertion holes are formed in the first region only, and a thickness extension portion or a through hole is formed in at least a portion of the second region.

### CROSS-REFERENCE TO RELATED APPLICATIONS

This application claims the benefit of priority under 35 U.S.C. §119 to Korean Patent Application No. 10-2010-0003566, filed on Jan. 14, 2010, in the Korean Intellectual Property Office, the disclosure of which is incorporated herein in its entirety by reference.

### BACKGROUND

1. Field of the Invention

The general inventive concept relates to a hard disk drive (HDD), and more particularly, to a disk clamp for fixing a disk for storing data to a spindle motor, and a spindle motor assembly including the disk clamp.

2. Description of the Related Art

Hard disk drives (HDDs), which are used in computers to store information, read data stored in a disk or write data to the disk using a read/write head. The disk is mounted on a spindle motor, and the read/write head is moved to a desired position by floating at a predetermined height from a recording surface of the rotating disk.

In a conventional HDD, a disk for storing data is assembled on a spindle motor, and is firmly fixed to the spindle motor by using a disk clamp. A hollow is formed in a central portion of the disk. The disk and the spindle motor are assembled by inserting a hub of the spindle motor into the hollow. However, since a clearance exists between an internal circumference of the hollow of the disk and an external circumference of the hub of the spindle motor in order to prevent interference during an assembly process, the disk may be eccentrically assembly with respect to a rotation center of the spindle motor. In this case, the disk may vibrate due to imbalance in mass distribution between the spindle motor and the disk when the spindle motor rotates, thereby reducing the reliability of data reading/writing performance on the disk.

### SUMMARY

The present general inventive concept provides a disk clamp having an asymmetric structure for compensating for imbalance in mass distribution due to eccentric assembly of a disk, and a spindle motor assembly including the disk clamp.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a disk clamp to fix a disk to a spindle motor of a hard disk drive (HDD), the disk clamp including a hollow formed in a central portion of the disk clamp, a coupling portion formed around an external circumference of the hollow, and including a plurality of screw insertion holes into which clamp fastening screws to be coupled to the spindle motor are inserted, and a pressing portion formed around an external circumference of the coupling portion to press the disk, wherein the coupling portion includes a first region and a second region that are asymmetrical with each other, and the plurality of screw insertion holes are formed in the first region only.

Features and/or utilities of the present general inventive concept may also be realized by a spindle motor assembly of a hard disk drive (HDD), the spindle motor assembly including a spindle motor, a disk to store data installed on the spindle motor, and the above disk clamp to fix the disk to the spindle motor.

The plurality of screw insertion holes may be spaced a predetermined interval apart in a circumferential direction in the first region of the coupling portion.

An angular range of the second region of the coupling portion may be about 50 to about 120 in a circumferential direction with respect to a center of the disk clamp.

The first region and the second region may have the same thickness. A center of the disk may be spaced apart from a rotation center of the spindle motor towards a predetermined direction, and the first region of the disk clamp may be disposed on a portion where the center of the disk is located with respect to the rotation center of the spindle motor.

The disk clamp may further include a through hole formed in at least a portion of the second region of the coupling portion. A center of the disk may be spaced apart from a rotation center of the spindle motor towards a predetermined direction, and the first region of the disk clamp may be disposed on a portion where the center of the disk is located with respect to the rotation center of the spindle motor.

The spindle motor assembly may further include a through hole formed in at least a portion of the second region of the coupling portion. A center of the disk may be spaced apart from a rotation center of the spindle motor towards a predetermined direction, and the second region of the disk clamp may be disposed on a portion where the center of the disk is located with respect to the rotation center of the spindle motor.

Features and/or utilities of the present general inventive concept may also be realized by a disk clamp including an outer rim to press against a disk, an inner rim to define a hole at a center of the disk clamp, and a coupling portion located between the outer rim and the inner rim, the coupling portion including a plurality of holes to receive screws to fix the disk clamp to a spindle motor, the coupling portion further including a first region corresponding to a first angle with respect to the center of the disk clamp and a second region corresponding to a second angle with respect to the center of the disk clamp, such that the first and second angles combine to 360°. The first region may correspond to an angle greater than the second region, and the first region may have a weight per unit of area different than the second region.

The second region may include no screw holes.

A thickness of the coupling portion of the second region may be greater than a thickness of the coupling portion of the first region.

The second region may include a plate mounted to the coupling portion.

The plate may include screw holes to pass screws through the plate and the coupling portion to mount the plate to the spindle motor.

The second region may include a through hole larger than each of the plurality of screw holes.

The second angle may be between 50 and 120 degrees.

Features and/or utilities of the present general inventive concept may also be realized by a spindle motor assembly including a spindle motor, a disk mounted to the spindle motor, and a disk clamp mounted to the spindle motor to press against the disk to fix the disk to the spindle motor. The disk clamp may include an outer rim to press against the disk, an inner rim to define a hole at a center of the disk clamp, and a coupling portion located between the outer rim and the inner rim, the coupling portion including a plurality of holes to receive screws to fix the disk clamp to the spindle motor, the coupling portion further including a first region corresponding to a first angle with respect to the center of the disk clamp and a second region corresponding to a second angle with respect to the center of the disk clamp, such that the first and second angles combine to 360°. The first region may correspond to an angle greater than the second region, and the first region may have a weight per unit of area different than the second region.

A weight per unit area of the second region may be greater than the first region, a center of the disk may be offset in a first direction with respect to a center of rotation of the spindle motor, and the first region may be located above the disk on a side of the disk corresponding to the first direction.

A weight per unit area of the second region may be less than the first region, a center of the disk may be offset in a first direction with respect to a center of rotation of the spindle motor, and the second region may be located above the disk on a side of the disk corresponding to the first direction.

### BRIEF DESCRIPTION OF THE DRAWINGS

Exemplary embodiments of the present general inventive concept will be more clearly understood from the following detailed description taken in conjunction with the accompanying drawings in which:

FIG. 1 is a perspective view of a hard disk drive (HDD) including a disk clamp according to an embodiment of the present general inventive concept;

FIG. 2 is a perspective view of the disk clamp of FIG. 1, according to an embodiment of the present general inventive concept;

FIG. 3 is a cross-sectional view of a spindle motor assembly including the disk clamp, taken along a line X1-X2 of FIG. 1, according to an embodiment of the present general inventive concept;

FIG. 4 is a perspective view of a disk clamp according to another embodiment of the present general inventive concept;

FIG. 5 is a cross-sectional view of the disk clamp taken along a line X3-X4 of FIG. 4, according to another embodiment of the present general inventive concept;

FIG. 6 is a perspective view of a disk clamp according to another embodiment of the present general inventive concept; and

FIG. 7 is a cross-sectional view of a spindle motor assembly including the disk clamp, taken along a line X5-X6 of FIG. 6, according to another embodiment of the present general inventive concept.

FIG. 8 is a cross-sectional view of a disk clamp according to another embodiment of the present general inventive concept.

FIG. 9 is a perspective view of a spindle motor assembly according to another embodiment of the present general inventive concept.

FIG. 10 is a cross-sectional view of a spindle motor assembly according to another embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

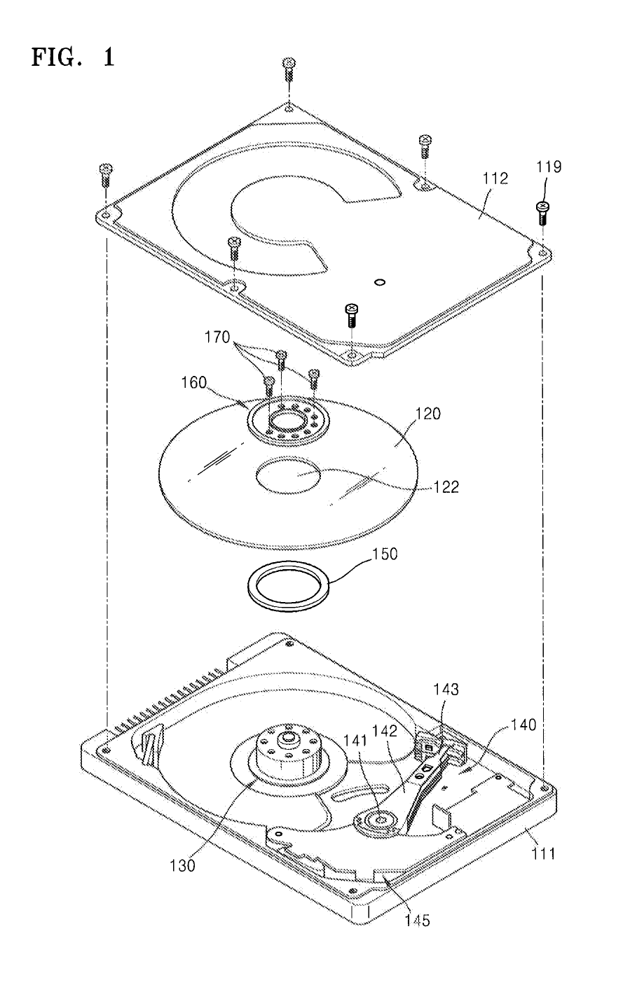

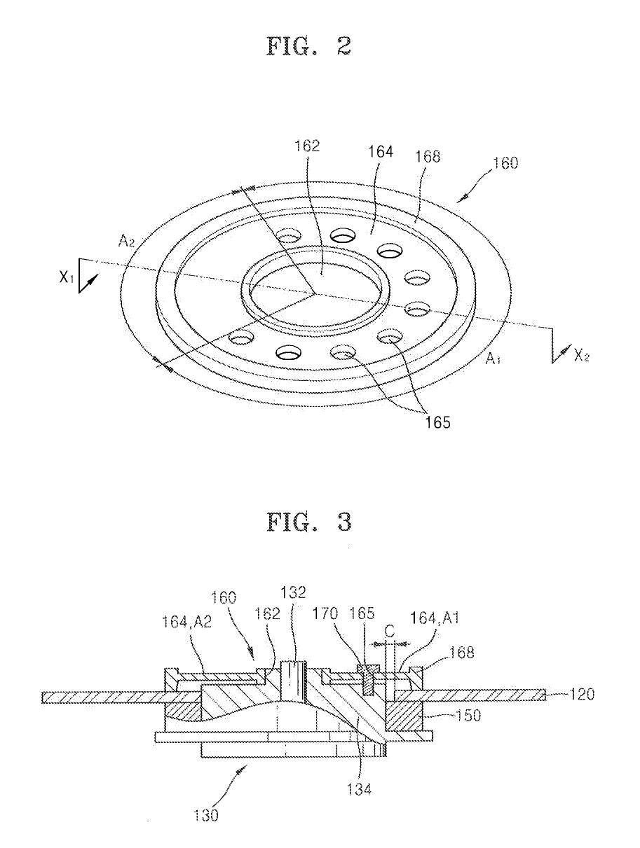

FIG. 1 is a perspective view of a hard disk drive (HDD) including a disk clamp 160 according to an embodiment of the present general inventive concept. FIG. 2 is a perspective view of the disk clamp 160 of FIG. 1, according to an embodiment of the present general inventive concept. FIG. 3 is a cross-sectional view of a spindle motor assembly including the disk clamp 160, taken along a line X1-X2 of FIG. 1, according to an embodiment of the present general inventive concept.

Referring to FIGS. 1 through 3, the HDD includes a base member 111, a cover member 112, the spindle motor assembly including a disk 120 for storing data and a spindle motor 130, and an actuator 140 for moving a read/write head for recoding and reproducing data to a predetermined position over the disk 120.

The spindle motor assembly and the actuator 140 are installed on the base member 111. The cover member 112 is assembled on the base member 111 via a plurality of cover fastening screws 119. The base member 111 and the cover member 112 jointly surround and protect the disk 120, the spindle motor 130, the actuator 140, and so on.

The actuator 140 includes a swing arm 142, a head gimbal assembly 143, and a voice coil motor (VCM) 145. The swing arm 142 is rotatably coupled to an actuator pivot 141 installed on the base member 111. The head gimbal assembly 143 is coupled to a front end of the swing arm 142 and elastically biases a slider on which the read/write head is mounted towards a surface of the disk 120. The VCM 145 rotates the swing arm 142.

The VCM 145 provides a torque for rotating the swing arm 142, and is controlled by a servo control system. The VCM 145 rotates the swing arm 142 in a direction according to Fleming's Left Hand Rule due to an interaction between a current input to a VCM coil and a magnetic field formed by magnets. That is, when the HDD is turned on and the disk 120 begins to rotate, the VCM 145 rotates the swing arm 142 in one direction to move the read/write head over a recording surface of the disk 120. In contrast, when the HDD is turned off and the disk 120 stops rotating, the VCM 145 rotates the swing arm 142 in the opposite direction to separate the read/write head from the recording surface of the disk 120.

The spindle motor assembly according to the present embodiment may include the spindle motor 130, the disk 120 for storing data, the disk clamp 160, and a disk spacer 150.

The spindle motor 130 rotates the disk 120 and includes a shaft 132, and a rotator, that is, a hub 134. The hub 134 is rotatably coupled to the shaft 132, and a bearing (not shown) is interposed between the shaft 132 and the hub 134. A hollow or hole 122 is formed in a central portion of the disk 120. The disk 120 and the spindle motor 130 are assembled by inserting the hub 134 of the spindle motor 130 into the hollow 122.

The disk clamp 160 firmly fixes the disk 120 to the hub 134 of the spindle motor 130. The disk clamp 160 is coupled to an upper end portion of the spindle motor 130, for example, to an upper end portion of the hub 132 by using clamp fastening screws 170 to vertically press the disk 120.

The disk spacer 150 is fitted around the external circumference of the hub 132 of the spindle motor 130 and supports the disk 120. For example, if the hub 134 of the spindle motor 130 is high enough, the disk spacer 150 may maintain a height of the disk 120. If the hub 134 of the spindle motor 130 is sufficiently low, the disk spacer 150 may not be used. In addition, when a plurality of disks 120 are mounted on the hub 134 of the spindle motor 130, the disk spacer 150 is interposed between the disks 120 to maintain a distance between the disks 120.

In the spindle motor assembly, since a clearance C exists between an internal circumference of the hollow 122 of the disk 120 and an external circumference of the hub 134 of the spindle motor 130 in order to prevent interference during an assembly process, the disk 120 may be eccentrically assembled with respect to the rotation center of the spindle motor 130. In this case, the disk 120 may vibrate due to imbalance in mass distribution between the spindle motor 130 and the disk 120 when the spindle motor 130 rotates, thereby reducing the reliability of data reading/writing performance on the disk 120.

The disk clamp 160 has an asymmetric structure in order to compensate for the imbalance in the mass distribution due to the eccentric assembly of the disk 120. In detail, the disk clamp 160 includes a hollow 162 formed in the central portion thereof, a coupling portion 164 formed around an external circumference of the hollow 162, and a pressing portion 168 formed around an external circumference of the coupling portion 164.

The pressing portion 168 has a rim shape, and is formed around an external circumference of the disk clamp 160. The pressing portion 168 contacts an upper surface of the disk 120 to vertically press the disk 120.

The coupling portion 164 has a ring shape, and includes a first region A1 and a second region A2 that are asymmetrical with each other in a circumferential direction or according to an angular range of the coupling portion 164. The first region A1 and the second region A2 may have the same thickness. A plurality of screw insertion holes 165 are formed in the first region A1 in a circumferential direction thereof. However, the second region A2 has no screw insertion holes. Accordingly, the mass per unit area of the second region A2 is greater than that of the first region A1.

The screw insertion holes 165 formed in the first region A1 of the coupling portion 164 may be spaced a predetermined interval apart in a circumference having a predetermined diameter. Three or more clamp fastening screws 170 may be inserted into the screw insertion holes 165. For example, when three clamp fastening screws 170 are used, as shown in FIG. 1, the three clamp fastening screws 170 are respectively inserted into three screw insertion holes 165 formed at an interval corresponding to 120 degrees. Thus, the first region A1 may be formed within an angular range of at least 240 degrees with respect to the center of the disk clamp 160, and the second region A2 may be formed within an angular range of 120 degrees or less with respect to the center of the disk clamp 160. If four clamp fastening screws 170 are used, the four clamp fastening screws 170 are respectively inserted into four screw insertion holes 165 formed at an interval corresponding to 90 degrees. Thus, the first region A1 may be formed within an angular range of at least 270 degrees with respect to the center of the disk clamp 160, and the second region A2 may be formed within an angular range of 90 degrees or less with respect to the center of the disk clamp 160. Likewise, if six clamp fastening screws 170 are used, the second region A2 may be formed within an angular range of 60 degrees or less, for example, about 50 degrees with respect to the center of the disk clamp 160. Thus, when an angular range of the second region A2 is measured in a circumferential direction with respect to the center of the disk clamp 160, the angular range of the second region A2 may be about 50 to about 120 degrees.

As described above, the number of clamp fastening screws 170 used to couple the disk clamp 160 to the spindle motor 130 may vary, and thus an angular range of each of the first region A1 and the second region A2 may vary. In addition, the angular range of each of the first region A1 and the second region A2 may be appropriately adjusted according to the degree of imbalance in mass distribution due to the eccentric assembly of the disk 120.

Next, referring to FIG. 3, when the disk 120 is assembled around the hub 134 of the spindle motor 130, the disk 120 is assembled by being pushed towards a predetermine direction, for example, towards the right direction. Consequently, the center of the disk 120 is spaced apart from the rotation center of the spindle motor 130 towards a predetermined direction, for example, towards the right direction, rather than matching the rotation center of the spindle motor 130. Thus, the clearance C between the internal circumference of the hollow 122 of the disk 120 and the external circumference of the hub 134 is biased towards the right direction with respect to the rotation center of the spindle motor 130.

As described above, when the disk 120 is eccentrically assembled with respect to the rotation center of the spindle motor 130, a larger local mass of the disk 120 is imposed on a right portion of the spindle motor 130, that is, a portion where the center of the disk 120 is located with respect to the center of the spindle motor 130. In addition, a smaller local mass of the disk 120 is imposed on a left portion of the spindle motor 130 with respect to the center of the spindle motor 130. In this case, the disk clamp 160 is assembled on the spindle motor 130 by using the clamp fastening screws 170 in such a way that the second region A2 of the disk clamp 160 is disposed on the left portion of the spindle motor 130 with respect to the center of the spindle motor 130, and the first region A1 is disposed on the right portion of the spindle motor 130 where the center of the disk 120 exists. Thus, the second region A2 of the disk clamp 160 having a large mass per unit is disposed on the left portion on which a smaller local mass of the disk 120 is imposed with respect to the center of the spindle motor 130, and the first region A1 of the disk clamp 160 having a small mass per unit is disposed on the right portion on which a larger local mass of the disk 120 is imposed with respect to the center of the spindle motor 130, thereby compensating for the imbalance in mass distribution due to the eccentric assembly of the disk 120.

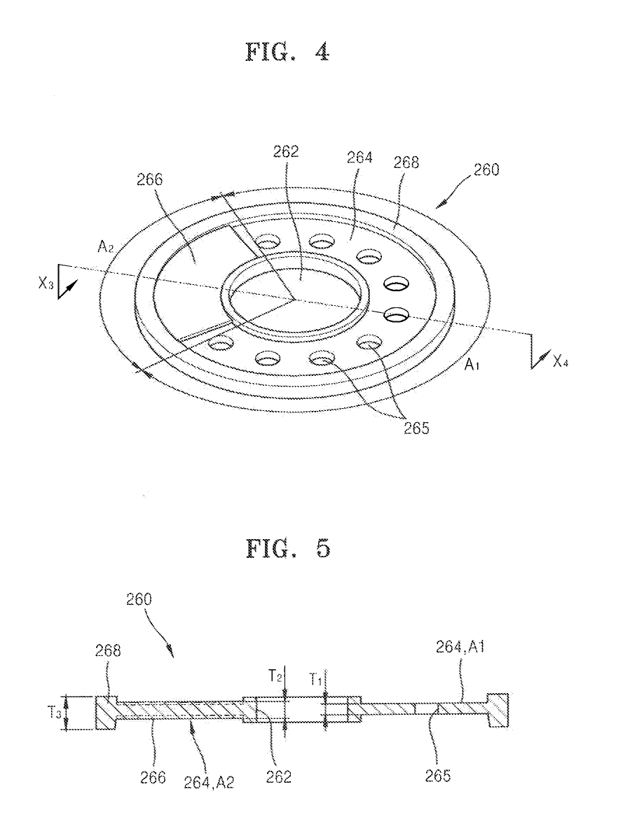

FIG. 4 is a perspective view of a disk clamp 260 according to another embodiment of the present general inventive concept. FIG. 5 is a cross-sectional view of the disk clamp 260 taken along a line X3-X4 of FIG. 4, according to another embodiment of the general inventive concept.

Referring to FIGS. 4 and 5, the disk clamp 260 has an asymmetric structure in order to compensate for the imbalance in the mass distribution due to the eccentric assembly of the disk 120. In detail, the disk clamp 260 includes a hollow or hole 262 formed in the central portion thereof, a coupling portion 264 formed around an external circumference of the hollow 262, and a pressing portion 268 formed around an external circumference of the coupling portion 264.

The pressing portion 268 has a rim shape, and is formed around an external circumference of the disk clamp 260. The pressing portion 268 contacts an upper surface of the disk 120 to vertically press the disk 120.

The coupling portion 264 has a ring shape, and includes a first region A1 and a second region A2 that are asymmetrical with each other. A plurality of screw insertion holes 265 are formed in the first region A1 in a circumferential direction thereof. However, the second region A2 has no screw insertion holes. Thus, the mass per unit area of the second region A2 is greater than that of the first region A1. The screw insertion holes 265 formed in the first region A1, and an angular range of each of the first region A1 and the second region A2 are the same as those in FIGS. 1 through 3, and thus their details will not be repeated.

According to the present embodiment, a thickness extension portion 266 is formed on the second region A2 of the coupling portion 264. A thickness T2 of the thickness extension portion 266 may be greater than a thickness T1 of the first region A1, and may be smaller than a thickness T3 of the pressing portion 268. The thickness extension portion 266 may be formed on two surfaces of the second region A2, or on an upper surface of the second region A2 only. Like in FIGS. 1 through 3, the angular range of the second region A2 may be about 50 to about 120 degrees with respect to the center of the disk clamp 260. The thickness extension portion 266 may be formed on an entire or partial portion of the second region A2. For example, an angular range of the thickness extension portion 266 may be about 20 to about 120 degrees.

As described above, when the thickness extension portion 266 is formed on the second region A2 of the coupling portion 264, the difference in the mass per unit area between the first region A1 and the second region A2 may be increased compared to the case of FIGS. 1 though 3. Thus, when the disk clamp 260 according to the inventive concept is used, even if imbalance mass distribution due to the eccentric assembly of the disk 120 is serious, the imbalance may be easily compensated for.

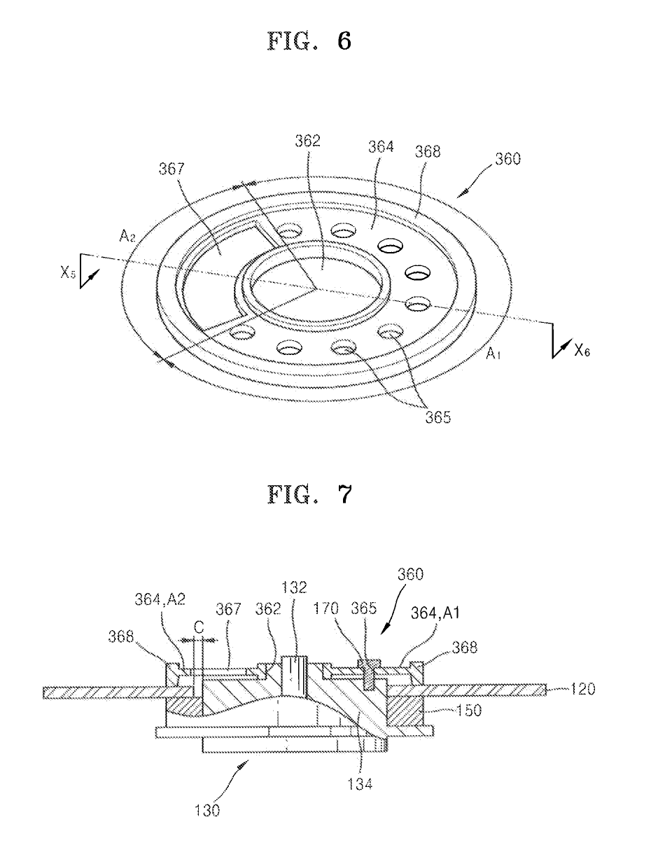

FIG. 6 is a perspective view of a disk clamp 360 according to another embodiment of the present general inventive concept. FIG. 7 is a cross-sectional view of a spindle motor assembly including the disk clamp 360, taken along a line X5-X6 of FIG. 6, according to another embodiment of the general inventive concept.

Referring to FIG. 6, the disk clamp 360 has an asymmetric structure in order to compensate for the imbalance in the mass distribution due to the eccentric assembly of the disk 120. In detail, the disk clamp 360 includes a hollow or hole 362 formed in the central portion thereof, a coupling portion 364 formed around an outer circumference of the hollow 362, and a pressing portion 368 formed around an external circumference of the coupling portion 364.

The pressing portion 368 has a rim shape, and is formed around an external circumference of the disk clamp 360. The pressing portion 368 contacts an upper surface of the disk 120 to vertically press the disk 120.

The coupling portion 364 has a ring shape, and includes a first region A1 and a second region A2 that are asymmetrical with each other. A plurality of screw insertion holes 365 are formed in the first region A1 in a circumferential direction thereof. A through hole 367, instead of the screw insertion holes 365, is formed in the second region A2. Thus, the mass per unit area of the second region A2 is smaller than that of the first region A1. The screw insertion holes 365 formed in the first region A1, and an angular range of each of the first region A1 and the second region A2 are the same as those in FIGS. 1 through 3, and thus their details will not be repeated.

According to the present embodiment, as described above, the through hole 367 is formed in the second region A2 of the coupling portion 264. Like in FIGS. 1 through 3, the angular range of the second region A2 may be about 50 to about 120 degrees with respect to the center of the disk clamp 360. The through hole 367 may be formed in an entire or partial portion of the second region A2. For example, an angular range of the through hole 367 may be about 20 to about 120 degrees. The through hole 367 may have an area larger than the screw insertion holes 365. For example, the through hole 367 may span a majority of a distance between the rim of the disk clamp 360 adjacent to the hollow 362 and the pressing portion 368. For example, the through hole 367 may span 80-90% of the distance in the radial direction.

Next, referring to FIG. 7, when the disk 120 is assembled around the hub 134 of the spindle motor 130, the disk 120 is assembled by being pushed towards a predetermined direction, for example, towards the left direction. Then, the center of the disk 120 is spaced apart from the rotation center of the spindle motor 130 towards a predetermined direction, for example, towards the left direction, rather than matching the rotation center of the spindle motor 130. Thus, the clearance C between the internal circumference of the hollow 122 of the disk 120 and the external circumference of the hub 134 is biased towards the left direction with respect to the rotation center of the spindle motor 130.

As described above, when the disk 120 is eccentrically assembled with respect to the rotation center of the spindle motor 130, a larger local mass of the disk 120 is located on a left portion of the spindle motor 130, that is, a portion where the center of the disk 120 exists with respect to the center of the spindle motor 130. In addition, a smaller local mass of the disk 120 is imposed on a right portion of the spindle motor 130 with respect to the center of the spindle motor 130. In this case, the disk clamp 360 is assembled on the spindle motor 130 by using the clamp fastening screws 170 in such a way that the first region A1 of the disk clamp 360 is disposed on the right portion of the spindle motor 130 with respect to the center of the spindle motor 130, and the second region A2 is disposed on the left portion of the spindle motor 130 where the center of the disk 120 exists. Thus, the second region A2 of the disk clamp 360 having a small mass per unit is disposed on the left portion on which a larger local mass of the disk 120 is imposed with respect to the center of the spindle motor 130, and the first region A1 of the disk clamp 360 having a large mass per unit is disposed on the right portion on which a smaller local mass of the disk 120 is imposed with respect to the center of the spindle motor 130, thereby compensating for the imbalance in mass distribution due to the eccentric assembly of the disk 120.

As described above, when the disk clamps 160, 260, and 360 according to the embodiments of the present general inventive concept are used, the imbalance in mass distribution due to the eccentric assembly of the disk 120 may be correctly compensated for. In addition, since each of the disk clamps 160, 260, and 360 has an asymmetric structure, the imbalance in mass distribution may be easily compensated for without additional elements, for example, a compensation pin and a compensation plate. If the compensate pin, etc., are coupled to the disk clamps 160, 260, and 360, the disk clamps 160, 260, and 360 may be deformed. However, according to the embodiments of the present general inventive concept, the disk clamps 160, 260, and 360 are not deformed, thereby preventing reduction in performance of the disk 120 due to this deformation.

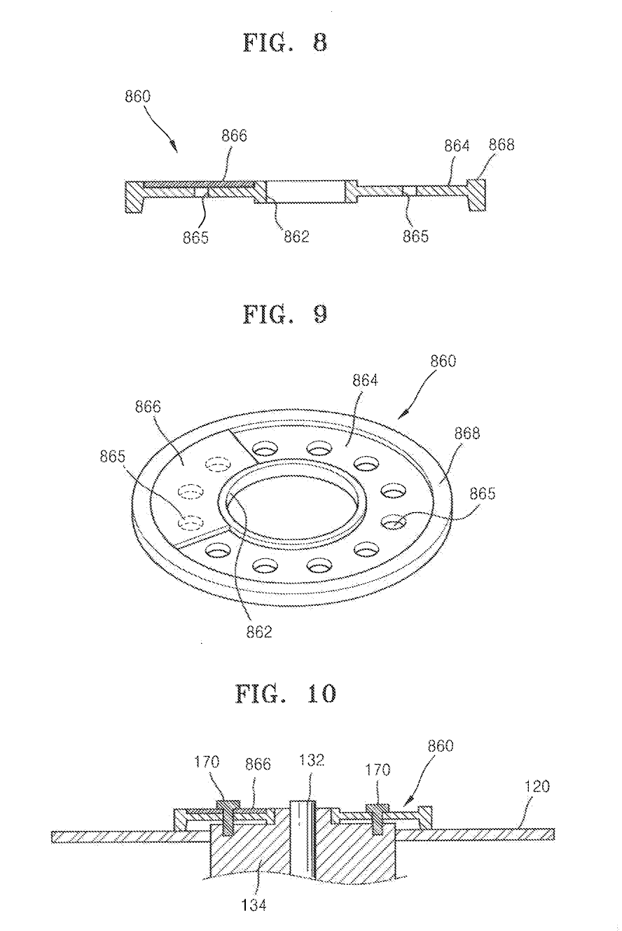

FIGS. 8 to 10 illustrate a disk clamp 860 according to another embodiment of the present general inventive concept. As illustrated in FIGS. 8 to 10, the disk clamp 860 may include a hole or hollow 862, a coupling portion 864, and a pressing portion 868 to press against a disk 120. The coupling portion 864 may include screw receiving holes 865 to receive screws to fix the disk clamp 860 to the spindle motor 130.

Similar to the disk clamps 160, 260, and 360 described above, the plate 866 of the disk clamp 860 may cover a portion of the coupling portion 864 that is asymmetrical with respect to a portion of the coupling portion 864 not covered by the plate 866. For example, the plate 866 may cover a portion of the coupling portion 864 corresponding to an angle of 90° with respect to a center of the disk clamp 860, and the portion of the coupling portion 864 not covered by the plate 866 may correspond to an angle of 270° with respect to a center of the disk clamp 860. The center of the disk clamp 860 may correspond to a point at a center of the hollow 862, for example.

The plate 866 may be attached to the coupling portion 864 either before or after the disk clamp 860 is affixed to a disk 120 and the spindle motor 130. For example, the disk clamp 860 may be placed on the disk 120, which is in turn mounted on the spindle motor 130. It may be determined the extent to which the disk is off-center, by weighing the assembly, by optical inspection, or by any other method. In response to the off-center determination, a plate of a corresponding size may be attached to one side of the disk clamp 860, and the disk clamp 860 may be affixed to the spindle motor 130 with screws 170.

The plate 866 may be affixed to the coupling portion 864 via an adhesive or welding. In such a case, the plate 866 may be a solid plate having no screw holes. Alternatively, as illustrated in FIG. 10, the plate 866 may include screw holes, and the plate 866 may be mounted to the spindle motor 130 with one or more screws 170.

Although one plate 866 is illustrated, a second plate may be mounted onto a lower surface of the disk clamp 860 opposite the plate 866. In addition, a plate thickness may vary according to a desired weight. For example, if it is determined that the disk 120 is off-center by a large degree, a thicker plate may be used; and if it is determined that the disk is off-center by a smaller degree, a thinner plate may be used.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. A disk clamp to fix a disk to a spindle motor of a hard disk drive (HDD), the disk clamp comprising
a hollow formed in a central portion of the disk clamp;
a coupling portion formed around an external circumference of the hollow, and comprising a plurality of screw insertion holes into which clamp fastening screws to be coupled to the spindle motor are inserted; and
a pressing portion formed around an external circumference of the coupling portion to press the disk,
wherein the coupling portion comprises a first region and a second region that are asymmetrical with respect to each other in a circumferential direction of the disk clamp, and
wherein the plurality of screw insertion holes are formed in the first region only.

2. The disk clamp of claim 1, wherein the plurality of screw insertion holes are spaced a predetermined interval apart in the circumferential direction in the first region of the coupling portion.

3. The disk clamp of claim 1, wherein an angular range of the second region of the coupling portion is about 50 to about 120 degrees in a circumferential direction with respect to a center of the disk clamp.

4. The disk clamp of claim 1, wherein the first region and the second region have the same thickness.

5. The disk clamp of claim 1, further comprising a thickness extension portion having a greater thickness than a thickness of the first region, and formed in at least a portion of the second region of the coupling portion.

6. The disk clamp of claim 1, further comprising a through hole formed in at least a portion of the second region of the coupling portion.

7. A spindle motor assembly of a hard disk drive (HDD), the spindle motor assembly comprising:
a spindle motor;
a disk to store data installed on the spindle motor; and
a disk clamp to fix the disk to the spindle motor,
wherein the disk clamp comprises:
a hollow formed in a central portion of the disk clamp;
a coupling portion formed around an external circumference of the hollow, and comprising a plurality of screw insertion holes into which clamp fastening screws to be coupled to the spindle motor are inserted; and
a pressing portion formed around an external circumference of the coupling portion to press the disk,
wherein the coupling portion comprises a first region and a second region that are asymmetrical with each other in a circumferential direction of the disk clamp, and
wherein the plurality of screw insertion holes are formed in the first region only.

8. The spindle motor assembly of claim 7, wherein the plurality of screw insertion holes are spaced a predetermined interval apart in the circumferential direction in the first region of the coupling portion.

9. The spindle motor assembly of claim 7, wherein the first region and the second region have the same thickness.

10. The spindle motor assembly of claim 9, wherein a center of the disk is spaced apart from a rotation center of the spindle motor towards a predetermined direction, and
wherein the first region of the disk clamp is located above the disk on a side of the disk corresponding to the predetermined direction.

11. The spindle motor assembly of claim 7, further comprising a thickness extension portion having a greater thickness than a thickness of the first region, and formed in at least a portion of the second region of the coupling portion.

12. The spindle motor assembly of claim 11, wherein a center of the disk is spaced apart from a rotation center of the spindle motor towards a predetermined direction, and
wherein the first region of the disk clamp is located above the disk on a side of the disk corresponding to the predetermined direction.

13. The spindle motor assembly of claim 7, further comprising a through hole formed in at least a portion of the second region of the coupling portion.

14. The spindle motor assembly of claim 13, wherein a center of the disk is spaced apart from a rotation center of the spindle motor towards a predetermined direction, and
wherein the second region of the disk clamp is located above the disk on a side of the disk corresponding to the predetermined direction.

15. A disk clamp, comprising:
an outer rim to press against a disk;
an inner rim to define a hole at a center of the disk clamp; and
a coupling portion located between the outer rim and the inner rim, the coupling portion including a plurality of holes to receive screws to fix the disk clamp to a spindle motor, the coupling portion further including a first region corresponding to a first angle with respect to the center of the disk clamp and a second region corresponding to a second angle with respect to the center of the disk clamp, such that the first and second angles combine to 360°,
wherein the first region corresponds to an angle greater than the second region, and
the first region has a weight per unit of area different than the second region.

16. The disk clamp according to claim 15, wherein the second region includes no screw holes.

17. The disk clamp according to claim 15, wherein a thickness of the coupling portion of the second region is greater than a thickness of the coupling portion of the first region.

18. The disk clamp according to claim 15, wherein the second region includes a plate mounted to the coupling portion.

19. The disk clamp according to claim 18, wherein the plate includes screw holes to pass screws through the plate and the coupling portion to mount the plate to the spindle motor.

20. The disk clamp according to claim 15, wherein the second region includes a through hole larger than each of the plurality of screw holes.

21. The disk clamp according to claim 15, wherein the second angle is between 50 and 120 degrees.
